(19) United States
(12) Patent Application Publication
(10) Pub. No.: US 2017/0225291 A1
(43) Pub. Date: Aug. 10, 2017

(54) URETHANE COMPOSITION AND POLISHING MATERIAL

(71) Applicant: DIC Corporation, Tokyo (JP)

(72) Inventors: Manabu TAKACHI, Osaka (JP); Naotaka GOTOH, Osaka (JP)

(21) Appl. No.: 15/501,725

(22) PCT Filed: Jun. 23, 2015
(86) PCT No.: PCT/JP2015/067994

§ 371 Date: Feb. 3, 2017

(30) Foreign Application Priority Data
Aug. 5, 2014 (JP) 2014-159443

(51) Int. Cl. B24B 37/24; B29C 39/22; C08G 18/12; B29C 39/02; C08G 18/66; C08G 18/76

(52) U.S. Cl. CPC B24B 37/24; C08G 18/6681; C08G 18/7621; C08G 18/12; B29C 39/02; B29C 39/22; B29K 2071/00

(57) ABSTRACT

An object which the present invention is to achieve is to provide a urethane composition capable of providing a molded product having excellent heat resistance and high hardness. The present invention is to provide a urethane composition containing a main agent (i) including a urethane prepolymer having an isocyanate group obtained by allowing a polyol (A) and a polyisocyanate (B) to react with each other, and a curing agent (ii), in which the polyol (A) includes a polyether polyol (a1) obtained by polymerizing an aromatic compound (a1-1) having two or more active hydrogen atom-containing groups and an alkylene oxide (a1-2), and a polishing material obtained by curing the urethane composition with heat, followed by slicing.

### TECHNICAL FIELD

The present invention relates to a urethane composition that can be particularly suitably used as a polishing material.

### BACKGROUND ART

In the field of liquid crystal displays (LCD), glass substrates for hard disks, silicon wafers, semiconductor devices, and the like, which requires a high degree of surface flatness, a polishing material is widely used so far.

In addition, in the manufacturing process of the liquid crystal display or the semiconductor device, a chemical mechanical polishing (CMP) method is widely used as a polishing method for imparting excellent surface flatness.

As the CMP method, generally, a free abrasive grain method which performs polishing by supplying a slurry, which is obtained by dispersing grains in an alkali solution or an acid solution (polishing liquid), at the time of polishing processing is adopted. That is, a material to be polished becomes flat through a mechanical action by the grains in the slurry and a chemical action by the alkali solution or the acid solution.

For example, as a polishing material that can be used in the CMP method, there is disclosed a polishing material obtained by using a urethane composition containing a urethane prepolymer, which is obtained by allowing polytetramethylene glycol, diethylene glycol, and polyisocyanate including toluene diisocyanate to react with one another, and 4,4′-methylene bis(o-chloroaniline) (for example, refer to PTL 1).

However, hardness of the polishing material is deteriorated by heat generated at the time of polishing process, so it is required that the heat resistance is further improved.

### CITATION LIST

### Patent Literature

PTL 1: JP-A-2007-77207

### SUMMARY OF INVENTION

### Technical Problem

An object of the present invention is to provide a urethane composition capable of providing a molded product being excellent in dress performance and heat resistance and having high hardness.

### Solution to Problem

The present invention provides a urethane composition containing a main agent (i) including a urethane prepolymer having an isocyanate group obtained by allowing a polyol (A) and a polyisocyanate (B) to react with each other, and a curing agent (ii), in which the polyol (A) includes a polyether polyol (a1) obtained polymerizing an aromatic compound (a1-1) having two or more active hydrogen atom-containing groups and an alkylene oxide (a1-2), and a polishing material obtained by curing the urethane composition with heat, followed by slicing.

### Advantageous Effects of Invention

A molded product, which can be obtained by curing the urethane composition of the present invention with heat, has excellent heat resistance, for example, to such an extent that the hardness is not deteriorated by heat generated at the time of polishing processing, is excellent in mechanical strength and dress performance, and has high hardness. Accordingly, the urethane composition of the present invention can be particularly suitably used as a material for a polishing material such as a polishing cloth, or a polishing pad.

### DESCRIPTION OF EMBODIMENTS

A urethane composition according to the present invention contains a main agent (i) including a urethane prepolymer having an isocyanate group which is obtained by allowing a polyol (A) including a polyether polyol (a1) obtained by polymerizing an aromatic compound (a1-1) having two or more active hydrogen atom-containing groups and an alkylene oxide (a1-2), and a polyisocyanate (B) to react with each other, and a curing agent (ii).

The polyether polyol (a1) is obtained by performing addition polymerization between an aromatic compound (a1-1) having two or more active hydrogen atom-containing groups and an alkylene oxide (a1-2) according to a known method, and is an essential component for obtaining a molded product having excellent dress performance, heat resistance, and high hardness. Typically, as a method for increasing the hardness of the urethane composition, a method of increasing an amount of a hard segment portion in a urethane resin, a method of introducing an aromatic polyester polyol for making a soft segment portion rigid, and the like may be used. However, in these methods, sufficient dress performance and heat resistance cannot be obtained.

Examples of the aromatic compound (a1-1) having two or more active hydrogen atom ([NH] group and/or [OH] group)-containing groups that can be used include an aromatic compound having a hydroxyl group such as bisphenol A, bisphenol F, bisphenol S, and an ethylene oxide adduct thereof, p-xylene glycol, 4,4′-dihydroxydiphenyl, 4,4′-dihydroxydiphenyl ether, 1,4-bis(2-hydroxyethyl)benzene, and 1,4-dihydroxybenzene; and an aromatic amine compound having a [NH] group such as 4,4′-diaminodiphenylmethane, 4,4′-diaminodiphenyl ether, o-xylylenediamine, m-xylylenediamine, p-xylylenediamine, tolylenediamine, and 2,2-bis[4-(4-aminophenoxy)phenyl]propane. These aromatic compounds may be used alone or in combination of two or more thereof. Among these, from the viewpoint of being capable of further improving dress performance and heat resistance, it is preferable to use an aromatic compound having a hydroxyl group, and it is more preferable to use one or more aromatic compounds selected from the group consisting of bisphenol A, 1,4-bis(2-hydroxyethyl)benzene, and 1,4-dihydroxybenzene.

Examples of the alkylene oxide (a1-2) that can be used include ethylene oxide, propylene oxide, 1,2-butylene oxide, 2,3-butylene oxide, tetrahydrofuran, and alkylated tetrahydrofuran. These compounds may be used alone or in combination of two or more thereof. Among these, from the viewpoint of being capable of further improving dress performance and heat resistance, it is preferable to use ethylene oxide and/or propylene oxide.

The number average molecular weight of the polyether polyol (a1) is preferably in a range of 300 to 5,000, more preferably in a range of 320 to 3,000, even more preferably in a range of 330 to 1,000, and particularly preferably in a range of 350 to 600 from the viewpoint of heat resistance and abrasion resistance. The number average molecular weight of the polyether polyol (a1) is a value measured by a gel permeation chromatography (GPC) method under the following conditions.

Measurement apparatus: high speed GPC apparatus (“HLC-8220GPC”, manufactured by Tosoh Corporation)

Columns: the following columns manufactured by Tosoh Corporation connected in series were used.

“TSKgel G5000” (7.8 mm I.D.×30 cm)×one column

“TSKgel G4000” (7.8 mm I.D.×30 cm)×one column

“TSKgel G3000” (7.8 mm I.D.×30 cm)×one column

“TSKgel G2000” (7.8 mm I.D.×30 cm)×one column

Detector: RI (refractive index detector)

Column temperature: 40° C.

Eluent: tetrahydrofuran (THF)

Flow rate: 1.0 mL/min

Injection volume: 100 μL (a tetrahydrofuran solution having a sample concentration of 0.4% by mass)

Standard sample: the calibration curve was formed using the following standard polystyrenes.

(Standard Polystyrenes)

“TSKgel Standard polystyrene A-500” manufactured by Tosoh Corporation

“TSKgel Standard polystyrene A-1000” manufactured by Tosoh Corporation

“TSKgel Standard polystyrene A-2500” manufactured by Tosoh Corporation

“TSKgel Standard polystyrene A-5000” manufactured by Tosoh Corporation

“TSKgel Standard polystyrene F-1” manufactured by Tosoh Corporation

“TSKgel Standard polystyrene F-2” manufactured by Tosoh Corporation

“TSKgel Standard polystyrene F-4” manufactured by Tosoh Corporation

“TSKgel Standard polystyrene F-10” manufactured by Tosoh Corporation

“TSKgel Standard polystyrene F-20” manufactured by Tosoh Corporation

“TSKgel Standard polystyrene F-40” manufactured by Tosoh Corporation

“TSKgel Standard polystyrene F-80” manufactured by Tosoh Corporation

“TSKgel Standard polystyrene F-128” manufactured by Tosoh Corporation

“TSKgel Standard polystyrene F-288” manufactured by Tosoh Corporation

“TSKgel Standard polystyrene F-550” manufactured by Tosoh Corporation

The polyol (A) may include a polyol other than the polyether polyol (a1) and for example, a polyether polyol (a2) other than the polyether polyol (a1), a polyester polyol, a polycarbonate polyol, a polybutadiene polyol, and a polyacrylic polyol can be used. These polyols may be used alone or in combination of two or more thereof. Among these, the polyether polyol (a2) is preferably included in the polyol (A) from the viewpoint of lowering the crystallinity of the polyol (A) by the combination with the polyether polyol (a1) to thereby improve manufacturing and workability.

Examples of the polyether polyol (a2) that can be used include polyoxyethylene polyols, polyoxypropylene polyols, polyoxytetramethylene polyols, polyoxyethylene polyoxypropylene polyols, polyoxyethylenepolyoxy tetramethylene polyols, and polyoxypropylenepolyoxy tetramethylene polyols. These polyether polyols may be used alone or in combination of two or more thereof. Among these, from the viewpoint of workability, polyoxypropylene polyols and/or polyoxytetramethylene polyols are preferably used.

The number average molecular weight of the polyether polyol (a2) is preferably in a range of 300 to 5,000, more preferably in a range of 320 to 3,000, even more preferably in a range of 330 to 1,000, and particularly preferably in a range of 350 to 600 from the viewpoint of workability. The number average molecular weight of the polyether polyol (a2) is a value measured in the same manner as in the measurement of the number average molecular weight of the polyether polyol (a1).

In the case of using the polyether polyol (a1) and the polyether polyol (a2) in combination, a mass ratio between the both polyether polyols [(a1)/(a2)] is preferably in a range of 1/99 to 50/50 and more preferably in a range of 5/95 to 30/70 from the viewpoint of being capable of maintaining heat resistance and workability at a high level.

In addition, in the case of using the polyether polyol (a1) and the polyether polyol (a2) in combination, the total mass of the (a1) and (a2) is preferably 80% by mass or more and more preferably 90% by mass or more in the polyol (A) from the viewpoint of heat resistance.

The polyol (A) may be used in combination with a chain extender (a3) as desired. Examples of the chain extender (a3) include glycols having a branched structure such as 2-methyl-1,5-pentanediol, 3-methyl-1,5-pentanediol, 1,2-butanediol, 1,3-butanediol, 2-butyl-2-ethyl-1,3-propanediol, 1,2-propanediol, 2-methyl-1,3-propanediol, neopentylglycol, 2-isopropyl-1,4-butanediol, 2,4-dimethyl-1,5-pentanediol, 2,4-diethyl-1,5-pentanediol, 2-ethyl-1,3-hexanediol, 2-ethyl-1,6-hexanediol, 3,5-heptanediol, 2-methyl-1,8-octanediol, and 2-(2-hydroxy-propoxy)-propan-1-ol; chain extenders having a hydroxyl group such as ethylene glycol, diethylene glycol, triethylene glycol, 1,3-propanediol, 1,4-butanediol, hexamethylene glycol, 4,4′-dihydroxy diphenyl, 4,4′-dihydroxy diphenyl ether, 4,4′-dihydroxy diphenyl sulfone, hydrogenated bisphenol A, hydroquinone, and trimethylol propane; and chain extenders having an amino group such as ethylene diamine, propane diamine, hexane diamine, isoholon diamine, phenylene diamine, 4,4′-diamino-3,3′-dichlorodiphenylmethane, and polyamino chlorophenyl methane compounds. These chain extenders may be used alone or in combination of two or more thereof.

The number average molecular weight of the chain extender (a3) is preferably from 80 to 290 from the viewpoint of mechanical strength. The number average molecular weight of the chain extender (a3) exhibits a value measured in the same manner as in the measurement of the number average molecular weight of the polyether polyol (a1).

Examples of the polyisocyanate (B) include aromatic polyisocyanates such as 4,4′-diphenylmethane diisocyanate, toluene diisocyanate, naphthalene diisocyanate, xylylen diisocyanate, and phenylene diisocyanate; aliphatic polyisocyanates such as ethylene diisocyanate, hexamethylene diisocyanate, and trimethyl hexamethylene diisocyanate; and alicyclic polyisocyanates such as isophorone diisocyanate, cyclohexane diisocyanate, dicyclohexylmethane diisocyanate, norbornane diisocyanate, and hydrogenated xylylene diisocyanate. These polyisocyanates may be used alone or in combination of two or more thereof. Among these, from the viewpoint of being capable of further increasing hardness and improving abrasion resistance, aromatic polyisocyanates are preferably used, and 4,4′-diphenylmethane diisocyanate and/or toluene diisocyanate is more preferable.

The urethane prepolymer is obtained by allowing the polyol (A) and the polyisocyanate (B), and if necessary, the chain extender (a3) to react with each other according to a known method and has an isocyanate group.

When the urethane prepolymer is obtained, the molar ratio between the isocyanate group of the polyisocyanate (B) and the active hydrogen atom-containing groups of the polyol (A) and the chain extender (a3) (NCO/[OH+NH]) is preferably in a range of 1.3 to 6.5 and more preferably in a range of 1.5 to 5 from the viewpoint of obtaining high hardness and abrasion resistance.

The isocyanate group equivalent (hereinafter, abbreviated as “NCO equivalent”) of the urethane prepolymer is preferably in a range of 200 to 1,000 g/eq., more preferably in a range of 250 to 800 g/eq., even more preferably in a range of 300 to 500 g/eq. from the viewpoint of mechanical strength. The NCO equivalent of the urethane prepolymer is a value obtained by dissolving a sample in dry toluene, allowing the solution to react by adding an excessive di-n-butylamine solution, and performing back titration of the residual di-n-butylamine with a hydrochloric acid standard solution according to JIS K 7301:2003.

The curing agent (ii) preferably contains a compound having an active hydrogen atom ([NH] group and/or [OH] group)-containing group reacting with the isocyanate group of the urethane prepolymer and for examples, a compound (C) having two or more amino groups such as ethylene diamine, propane diamine, hexane diamine, isoholon diamine, phenylene diamine, 4,4′-diamino-3,3′-dichlorodi phenylmethane, or polyamino chlorophenyl methane compounds; and a compound having two or more hydroxyl groups such as ethylene glycol, diethylene glycol, propanediol, butanediol, hexanediol, neopentylglycol, 3-methyl-1,5-pentanediol, bisphenol A, alkylene oxide adducts of bisphenol A, polyether polyols, polyester polyols, polycaprolactone polyols, or polycarbonate polyols can be used. These curing agents may be used alone or in combination of two or more thereof. Among these, from the viewpoint of heat resistance and abrasion resistance, a compound (C) having two or more amino groups is preferably used and 4,4′-diamino-3,3′-dichlorodiphenylmethane is more preferably used.

The molar ratio between the active hydrogen atom-containing group of the curing agent (ii) and the isocyanate group of the urethane prepolymer (active hydrogen atom-containing group/NCO) is preferably in a range of 0.6 to 1 and more preferably in a range of 0.7 to 0.98 from the viewpoint of heat resistance and abrasion resistance.

The urethane composition of the present invention contains the main agent (i) containing the urethane prepolymer, and the curing agent (ii) as essential components, but my contain other additives as desired.

As other additives, for example, water, a urethanization catalyst, an antifoaming agent, grains, a filler, a pigment, a thickener, an antioxidant, an ultraviolet absorber, a surfactant, a flame retardant, a plasticizer, and the like can be used. One of or two or more of these additives may be respectively included in the main agent (i) and/or the curing agent (ii).

Examples of the method of obtaining a molded product by using the urethane composition include a method of pouring the urethane composition into a mold heated in advance in a range of 50° C. to 100° C., closing a cover of the mold, and curing the composition by heating at a temperature of 50° C. to 130° C. for 30 minutes to 20 hours, thereby obtaining a molded product. The molded product obtained by curing the composition with heat may be after-cured at a temperature of 50° C. to 130° C. for 30 minutes to 20 hours as desired.

Examples of the method of obtaining a polishing material by using the molded product include a method of slicing the molded product to have a thickness in a range of 0.5 to 50 mm with a slicer.

The storage elastic modulus (E′) of the polishing material at 70° C. is preferably in a range of 1.4×10⁹ to 2.5×10⁹ Pa, more preferably in a range of 1.7×10⁹ to 2.4×10⁹ Pa, and even more preferably in a range of 1.8×10⁹ to 2.3×10⁹ Pa from the viewpoint of being capable of further improving the hardness retaining properties of the polishing material at the heat generation temperature at the time of polishing and providing viscoelasticity for obtaining good dress performance. A method of measuring the storage elastic modulus (E′) of the polishing material at 70° C. will be described in Examples, which will be described later.

The molded product obtained by curing the urethane composition of the present invention with heat according to the present invention has excellent heat resistance, for example, such an extent that the hardness is not deteriorated by heat generated at the time of polishing processing, and also has excellent mechanical strength, excellent dress performance, and high hardness. Accordingly, the urethane composition of the present invention can be particularly suitably used as a material for a polishing material such as a polishing cloth or a polishing pad.

### EXAMPLES

Hereinafter, the present invention will be described in more detail using examples.

### Example 1

Into a four-neck flask equipped with a nitrogen-introducing tube, a thermometer, and a stirrer, 977 parts by mass of toluene diisocyanate (hereinafter, abbreviated as “TDI”), 300 parts by mass of “UNIOR DB-400”, manufactured by NOF CORPORATION (a polyether polyol obtained by polymerizing bisphenol A and propylene oxide, number average molecular weight: 400), 700 parts by mass of polyoxypropylene diol (number average molecular weight: 400, hereinafter, abbreviated as “PPG 400”), and 58 parts by mass of diethylene glycol (hereinafter, abbreviated as “DEG”) were put and mixed to conduct reaction in a nitrogen gas stream of 80° C. for 8 hours, and thus a urethane prepolymer having an isocyanate group having an NCO equivalent of 400 g/eq. was obtained.

Next, 100 parts by mass of the obtained urethane prepolymer and 30.1 parts by mass of 4,4′-diamino-3,3′-dichlorophenyl methane (hereinafter, abbreviated as “MOCA”) were mixed and stirred to prepare a urethane composition.

Next, the obtained urethane composition was immediately poured into a mold (100 mm×100 mm×50 mm) heated in advance at 50° C., a cover of the mold was immediately closed, and then the mold was left to stand at 50° C. for 1 hour. Then, a molded product was taken out. The molded product taken out was after-cured at 110° C. for 16 hours and sliced to have a thickness of 30 mm with a slicer, and thus a polishing material was obtained.

### Example 2

Into a four-neck flask equipped with a nitrogen-introducing tube, a thermometer, and a stirrer, 977 parts by mass of TDI, 150 parts by mass of “UNIOR DB-400”, manufactured by NOF CORPORATION, 850 parts by mass of PPG 400, and 58 parts by mass of DEG were put and mixed to conduct reaction in a nitrogen gas stream at 80° C. for 8 hours, and thus a urethane prepolymer having an isocyanate group having an isocyanate group equivalent of 400 g/eq. was obtained.

Next, 100 parts by mass of the obtained urethane prepolymer and 30.1 parts by mass of MOCA were mixed and stirred to prepare a urethane composition.

Next, the obtained urethane composition was immediately poured into a mold (100 mm×100 mm×50 mm) heated in advance at 50° C., a cover of the mold was immediately closed, and then the mold was left to stand at 50° C. for 1 hour. Then, a molded product was taken out. The molded product taken out was after-cured at 110° C. for 16 hours and sliced to have a thickness of 30 mm with a slicer, and thus a polishing material was obtained.

### Comparative Example 1

Into a four-neck flask equipped with a nitrogen-introducing tube, a thermometer, and a stirrer, 977 parts by mass of TDI, 1,000 parts by mass of PPG 400, and 58 parts by mass of DEG were put and mixed to conduct reaction in a nitrogen gas stream at 80° C. for 8 hours, and thus a urethane prepolymer having an isocyanate group having an isocyanate group equivalent of 400 g/eq. was obtained.

Next, 100 parts by mass of the obtained urethane prepolymer and 30.1 parts by mass of MOCA were mixed and stirred to prepare a urethane composition.

Next, the obtained urethane composition was immediately poured into a mold (100 mm×100 mm×50 mm) heated in advance at 50° C., a cover of the mold was immediately closed, and then the mold was left to stand at 50° C. for 1 hour. Then, a molded product was taken out. The molded product taken out was after-cured at 110° C. for 16 hours and sliced to have a thickness of 30 mm with a slicer, and thus a polishing material was obtained.

### Comparative Example 2

Into a four-neck flask equipped with a nitrogen-introducing tube, a thermometer, and a stirrer, 1,191 parts by mass of TDI, 700 parts by mass of polyoxytetramethylene glycol (number average molecular weight: 1,000, hereinafter, abbreviated as “PTMG 1000”), 300 parts by mass of an aromatic polyester polyol (number average molecular weight: 1,000, hereinafter, abbreviated as “aromatic PEs”) obtained by a reaction of neopentyl glycol and orthophthalic acid, and 289 parts by mass of DEG were put and mixed to conduct reaction in a nitrogen gas stream at 80° C. for 8 hours, and thus a urethane prepolymer having an isocyanate group having an isocyanate group equivalent of 400 g/eq. was obtained.

Next, 100 parts by mass of the obtained urethane prepolymer and 30.1 parts by mass of MOCA were mixed and stirred to prepare a urethane composition.

Next, the obtained urethane composition was immediately poured into a mold (100 mm×100 mm×50 mm) heated in advance at 50° C., a cover of the mold was immediately closed, and then the mold was left to stand at 50° C. for 1 hour. Then, a molded product was taken out. The molded product taken out was after-cured at 110° C. for 16 hours and sliced to have a thickness of 30 mm with a slicer, and thus a polishing material was obtained.

### [Evaluation Method of Heat Resistance]

The polishing material obtained in each of Examples and Comparative Examples was left to stand in a drier at 25° C. and 110° C. for one hour, and then, the hardness (JISD hardness) was measured. A hardness retention rate (%) was calculated from the obtained hardness to evaluate heat resistance. Specifically, the heat resistance in a case in which the hardness retention rate (%) was 90% or more was designated as “T”, and the heat resistance in a case in which the hardness retention rate was less than 90% was designated as “F”. The above-mentioned JISD hardness is evaluated by a spring hardness test, Type D, according to JIS K 7312-1996 (hardness test).

### [Evaluation Method of Dress Performance]

The amount of abrasion (mg) of the polishing material obtained in each of Examples and Comparative Examples was measured under the conditions of an abrasive wheel: CS-17, and a load: 1,000 g using a Taber type abrasion tester “rotary abrasion tester”, manufactured by Toyo Seiki Seisaku-sho, Ltd. The polishing material having an amount of abrasion of more than 160 (mg) was easily shaved and the dress performance was designated as “T” and the dress performance of the polishing material having an amount of abrasion of 160 (mg) or less was designated as “F”.

### [Measurement Method of Storage Elastic Modulus of Polishing Material]

The storage elastic modulus (E′) of the polishing material obtained in each of Examples and Comparative Examples was measured under the conditions of a temperature raising rate of 2° C./min, a measurement frequency of 1 Hz, a temperature range of 0° C. to 100° C., and a distortion of 0.5% using ARES viscoelasticity measurement apparatus (manufactured by TA Instruments Japan Co., Ltd.).

TABLE 1

| | Example | Example | Comparative | Comparative |
|---|---|---|---|---|
| | 1 | 2 | Example 1 | Example 2 |
| Main agent (i) | | | | |
| Urethane prepolymer | | | | |
| Polyol (A) | | | | |
| Polyether polyol (a1) | UNIOR | UNIOR | | |
| | DB-400 | DB-400 | | |
| Polyether polyol (a2) | PPG 400 | PPG 400 | PPG 400 | PTMG 1000 |
| (a1)/(a2) mass ratio | 30/70 | 15/85 | 0/100 | 0/100 |
| Other polyols | | | | Aromatic |
| | | | | PEs |
| Chain extender (a3) | DEG | DEG | DEG | DEG |
| Polyisocyanate (B) | TDI | TDI | TDI | TDI |
| Curing agent (ii) | MOCA | MOCA | MOCA | MOCA |
| Storage elastic | 2.11 × 10⁹ | 1.75 × 10⁹ | 1.26 × 10⁹ | 1.36 × 10⁹ |
| modulus (E′) | | | | |
| (Pa) at 70° C. | | | | |
| Heat resistance | | | | |
| Hardness (JISD) | 88 | 87 | 87 | 85 |
| at 25° C. | | | | |
| Hardness (JISD) | 82 | 79 | 71 | 73 |
| at 110° C. | | | | |
| Hardness retention | 93 | 91 | 82 | 86 |
| rate (%) | | | | |
| Evaluation | T | T | F | F |
| Dress performance | | | | |
| Amount of | 301 | 172 | 85 | 149 |
| abrasion (mg) | | | | |
| Evaluation | T | T | F | F |

It was found that the urethane compositions of Examples 1 and 2, which are the urethane compositions according to the present invention, provided polishing materials having high hardness and being excellent in heat resistance and dress performance.

On the other hand, in Comparative Example 1 in which the polyether polyol (a1) was not used, heat resistance and dress performance were poor.

In Comparative Example 2 in which an aromatic polyether polyol was used instead of the polyether polyol (a1), heat resistance and dress performance were poor.

1. A urethane composition comprising:
a main agent (i) including a urethane prepolymer having an isocyanate group obtained by allowing a polyol (A) and a polyisocyanate (B) to react with each other; and
a curing agent (ii),
wherein the polyol (A) includes a polyether polyol (a1) obtained by polymerizing an aromatic compound (a1-1) having two or more active hydrogen atom-containing groups and an alkylene oxide (a1-2).

2. The urethane composition according to claim 1,
wherein the active hydrogen atom-containing group in the aromatic compound (a1-1) is a hydroxyl group.

3. The urethane composition according to claim 1,
wherein the polyol (A) further includes a polyether polyol (a2) other than the polyether polyol (a1).

4. The urethane composition according to claim 3,
wherein a mass ratio between the polyether polyol (a1) and the polyether polyol (a2) [(a1)/(a2)] is in a range of 1/99 to 50/50.

5. The urethane composition according to claim 1,
wherein the curing agent (ii) includes a compound (C) having two or more amino groups.

6. A polishing material that is obtained by curing the urethane composition according to claim 1 with heat, followed by slicing.
